(19) United States
(12) Patent Application Publication
(10) Pub. No.: US 2005/0203698 A1
(43) Pub. Date: Sep. 15, 2005

(54) Navigation system using POI code numbers, and operating system and method therefor

(76) Inventor: Kyung-Jae Lee, Suwon-si (KR)

Correspondence Address: SHERIDAN ROSS PC, 1560 BROADWAY, SUITE 1200, DENVER, CO, 80202, US

(21) Appl. No.: 10/876,259

(22) Filed: Jun. 23, 2004

(30) Foreign Application Priority Data
Mar. 11, 2004 (KR) 10-2004-0016530

(51) Int. Cl. G01C 21/30

(52) U.S. Cl. 701/200; 340/995.1

(57) ABSTRACT

Disclosed is directed to a navigation system using POI code numbers, and an operating system and method thereof. In the system according to the invention, information matching to real states, including POI code numbers, local information, and business information, is stacked on a database to provide a user with geographic information obtained from searching an identical one matching to a POI code number entered by the user. If there has been an update for the geographic information, new POI code numbers are endowed with the updated information and then stored with being associated to the endowed POI code number. The invention also abstracts pre-registered user information using a vehicle navigation system and then updates the geographic information by transferring the POI code number and the undated information thereof to the vehicle navigation system through a communication network in accordance with the abstracted user information. The invention is able to simply search a destination by means of the POI code number.

### CROSS-REFERENCE TO RELATED APPLICATIONS

This U.S. non-provisional patent application claims priority under 35 U.S.C. § 119 of Korean Patent Application No. 10-2004-0016530 filed on Mar. 11, 2004, the entire contents of which are hereby incorporated by reference.

### BACKGROUND OF THE INVENTION

This disclosure relates to a navigation system capable of searching a destination using POI (Point of Interest) code numbers and operatively updating positioning information desired by a user on its geographic information by means of the POI code numbers, an operating system and method thereof.

It is now being generalized with a vehicle navigation system as a service for enabling a driver to easily drive the vehicle to a selected destination, informing him of the best route and traffic condition to the destination from a departure position.

The vehicle navigation system is usually comprised of a geographic information retrieval system for finding desired destinations.

In such a conventional vehicle navigation system, it is always necessary for a user to input predetermined data, relevant to geographic information desired by the user, by means of a key input unit, in order to obtain information about a specific location provided from the geographic information retrieval system.

Considering the features of geographic information retrieval systems or methodologies in the conventional vehicle navigation system in accordance with information input processes by users, there are several ways roughly classified into a lexicographic searching method in which a destination name is fully input to a searching windows of a monitor to obtain desired positioning information, a character-string searching method in which desired positioning information is provided just by inputting partial characters of a destination name, and a business category searching method that needs an input of a business category of a destination to be get around.

However, in the lexicographic searching method, since a user must stroke full characters of the destination name on a key input unit, it causes an increase of component numbers and the structural complexity because the key input unit should be comprised with a plurality of key pads, as like a keyboard of a personal computer, so as to provide all available characters as name. Moreover, it is usually frequent that a destination name input by a user is dissimilar to the public name registered therein, so that the desired geographic information cannot be easily provided to the user from the system.

In the character-string searching system, as all titles of institutions involved in the partial characters of the destination name partially input by the user are listed up on an index screen of the monitor, the user needs to scroll the plural titles up and down to find the desired destination name. Thus, when there are great deals of titles linked to the desired destination name, it takes a long time to find out an exact one matching to the desired destination name. Moreover, since a key input unit like a keyboard must stroke characters of the name or title, it also causes an increase of component numbers and the structural complexity. Or, it may cause inconvenience to a user because of the restricted input/output means in function.

Also in the business category searching method, it is difficult for a user, who does not engage in the corresponding business, to understand the business category classification system. And, in order to obviate too many results when an area to be searched is broad, a user is required to know at least an address not broader than the scope of a unit ward including a destination. Moreover, it is inconvenient because a user needs to perform a duplicate operation to directly input an area name to be searched.

On the other hand, the vehicle navigation system is, as well as a private car, also installed in a rent-a-car used by a tourist in a sightseeing area, by which the tourist enjoys his travels on moving to his favorite places with guidance of route for a selected destination with reference to a map.

The conventional vehicle navigation system usually offers the route guidance with geographic information retrieved from a storage device embedded therein, such as a CD-ROM.

However, it may be cumbersome to change an additionally purchased CD-ROM in order to update the geographic information data. Although a company producing the vehicle navigation system periodically offers the next CD-ROM with newly updated geographic information on sale, a long term of the renewal relative to variation of geographic conditions is not helpful in updating geographic information currently and immediately. Therefore, company customers in business around the resort are situated on disadvantageous condition to advertise themselves, because an immediate data update according to variation of geographic information is impossible even while they want to register their company on the geographic information field of the vehicle navigation system. The shortness in updating geographic information with delay may also cause the tourists to feel inconvenience in using the navigation system because they can not utilize new geographic information immediately.

In addition, rent-a-car providers may have a burden of cost in purchasing many CD-ROMs for updating because they manage a number of vehicles.

### SUMMARY OF THE INVENTION

Accordingly, for the purpose of solving the aforementioned problems, the present invention is directed to provide a navigation system and method for simply searching geographic information by means of POI code numbers.

The present invention is also directed to provide a navigation system using POI code numbers, and an operating system and method for the same, for immediately updating geographic information therein whenever there is new data to be updated currently, as well as utilizing the updated geographic information by means of the POI code numbers in convenience.

An aspect of the present invention is to provide an operating system for managing geographical information of a navigation system, comprising a navigating information server which comprises: a map information database for storing the geographic information matching to POI code numbers, including positioning information; a geographic information control unit for managing the map information database with the geographic information; and an update control unit for managing the geographic information control unit to update the geographic information, endowing the POI code number to update information when an update occurs, enabling the geographic information control unit to transmit updated geographic information including the POI code number to the vehicle navigation system.

Another aspect of the present invention is a navigation system using a POI code number, comprising: a map information database for storing a POI code number assigned to information about region and business, corresponding to an institutions involved in street and building names with high recognition; a display unit for outputting a signal corresponding to an operation control signal inputted thereto; an input unit for inputting the POI code number; and a controller for applying information matching with the POI code number to the display unit from the map information database, in accordance with the POI code number provided through the input unit.

The present invention also provides a method of operating a navigating information system having a navigating information server managing geographic information of a vehicle navigation system, comprising: a first step of endowing a POI code number to an update information when the update information for the geographic information is generated; a second step of storing the update information with matching to the endowed POI code number; a third step of abstracting pre-registered user information using the vehicle navigation system; and a fourth step of transmitting the POI code number and the update information matching to the POI code number to the vehicle navigation system by way of a communication network in accordance with the abstracted user information in the third step.

The present invention also provides a method for searching with a navigation system applying information to a display unit when inputting a name of a target institution through an input unit, comprising: a first step of establishing a database by endowing POI code numbers to institutions and matching the POI numbers with geographic information including information about region and business; a second step of receiving a POI code number supplied from the input unit; and a third step of providing the geographic information of a corresponding institution to a user by searching the POI code number received in the second step, abstracting the geographic information matching to the POI code number, and applying the geographic information to the display unit.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain principles of the present invention. In the drawings:

FIG. 1 is a block diagram illustrating an interfacing configuration of a navigation operating system using POI code numbers in accordance with the present invention;

FIG. 2 is a block diagram illustrating a vehicle navigation system in accordance with the present invention;

FIG. 3 is an exemplary diagram showing a classification formula of the representative POI code numbers in accordance with an embodiment of the present invention;

FIG. 4 is an exemplary diagram showing a subordinate POI list in accordance with an embodiment of the present invention;

FIG. 5 is a schematic diagram illustrating an example of denoting mileposts in accordance with the present invention;

FIG. 6 is a flow chart showing a method of searching POI code numbers;

FIG. 7 is a block diagram illustrating a configuration of a navigating information server;

FIG. 8 is a block diagram of a configuration for requesting information registry by a user, according to the present invention;

FIG. 9 is a flow chart showing a procedure of requesting registry by way of a mobile communication terminal or a wired terminal, according to the present invention;

FIG. 10 is a flow chart showing a procedure of requesting registry by way of a mobile communication terminal or a personal terminal, according to the present invention;

FIG. 11 is a flow chart showing a procedure of requesting registry by way of a short message service, according to the present invention;

FIGS. 12 through 14 are schematic diagrams illustrating implementations of geographic information in accordance with the present invention;

FIG. 15 is a flow chart showing a procedure of updating geographic information in accordance with the present information; and

FIG. 16 is a flow chart showing another procedure of updating geographic information in accordance with the present information.

### DETAILED DESCRIPTION OF PREFERRED EMBODIMENTS

Preferred embodiments of the present invention will now be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the invention to those skilled in the art. Like numerals refer to like elements throughout the specification.

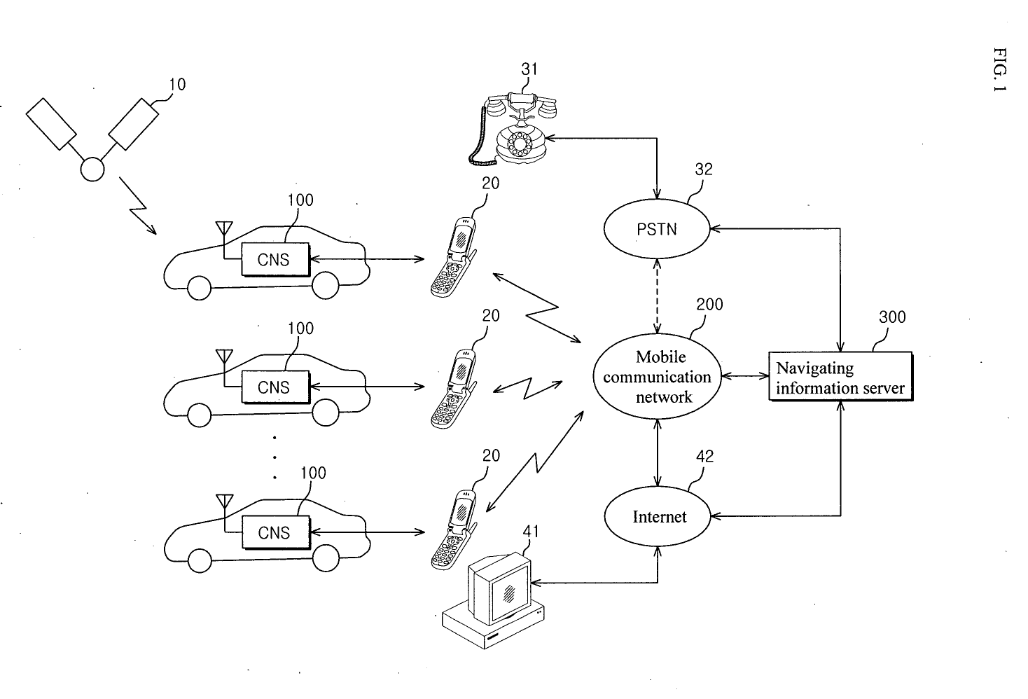

FIG. 1 is a block diagram illustrating an interfacing configuration of a navigation operating system using POI code numbers in accordance with the present invention.

Referring to FIG. 1, the system according to the present invention, as a system installed in a vehicle to receive signals transmitted from a GPS satellite 10 and update geographic information by means of a vehicle navigation system (hereinafter, referred to as “CNS”) 100 offering information of navigation to drivers, includes a navigating information server 300 for renewing the geographic information in accordance with a registry request of geographic information applied from a user and updating the renewed geographic information to a database of the CNS 100 connected to a mobile communication terminal 20 by way of a mobile communication network 200.

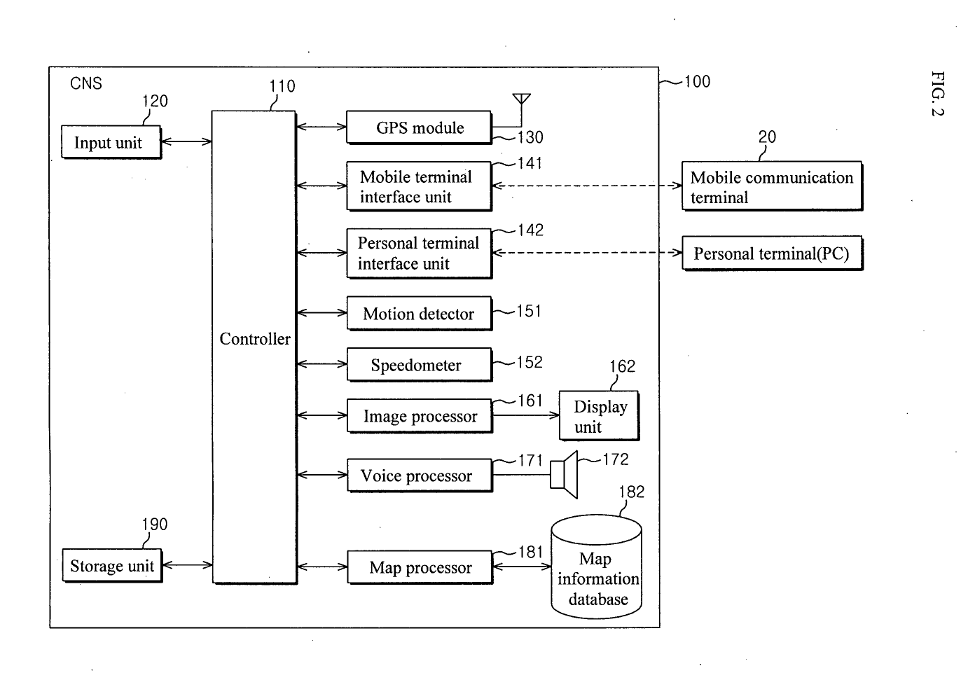

FIG. 2 is a block diagram illustrating a vehicle navigation system (CNS) in accordance with the present invention.

Referring to FIG. 2, the CNS 100 according to the present invention is comprised of a controller 110 for operating an overall process, an input unit 120 for receiving information from a user, and a GPS module 130 for receiving and processing information signals transmitted from the GPS satellite 10.

Additionally, the CNS 100 of the present invention includes a motion detector 151 for sensing a traveling condition of a vehicle, a speedometer 152 for detecting a current speed of the vehicle, an image processor 161 for processing video information including the navigating information and then displaying the video information on a display unit 162, a voice processor 171 for processing audio information and then outputting the audio information through a speaker 172, a map processor 181 for managing and processing the geographic information with GPS data provided by the GPS module 130, a map information database 182 for storing the geographic information, and a storage unit 190 having program files and data used in operating the system.

The CNS 100 according to the present invention is configured with also including a mobile terminal interface 141 for enabling a connection with the navigating information server 300 by way of the mobile communication terminal 20, and a personal terminal interface 142 for connecting with a personal terminal (PC). The personal terminal interface 142 may be easily implemented with a USB, or other various means such as a serial port, a parallel port, an IEEE 1394, wired/wireless LAN, and so on.

The input unit 120 is comprised of a key pad, a remote controller, or a touch screen installed in the display unit 162.

The motion detector 151, for sensing a traveling condition of a vehicle, may be made of a yaw rate sensor or a gyro-sensor. The speedometer 152, for detecting a traveling speed of a vehicle, detects the traveling speed by itself or receives a speed data from an ECU (not shown) built in the vehicle.

In this embodiment, while the CNS 100 has the mobile terminal interface 141 for connection with an external mobile communication terminal, it is also available to directly connect with the mobile communication network 200 by embedding a radio module for mobile communication in the system.

With the CNS 100 of the aforementioned constitution in accordance with the present invention, predetermined POI code numbers and geographic information matching with the POI code numbers are stored in the map information database 182. When there is an input of a POI code number by a user through the input unit 120, the controller 110 operates the map processor 181 to abstract a positioning data (e.g., coordinate information) and item (e.g., the position name), corresponding to the POI code number, from the map information database 182. Then, the abstracted information is displayed on the display unit 162 by way of the video processor 161. On the other side, in the step of inputting the POI code number, even when it is impossible to know a proper POI code number because a user cannot remember the predetermined POI code number or does not have a handbook in which the POI code numbers are written with reference to destination names, the user is able to connect with an ARS (not shown) or an internet server (not shown) accessible to the map information database and then input a desired destination name thereto by characters or a voice. By such an accessing operation, a POI code number matching to the desired destination name is provided to the user from the ARS or the internet server, and then the user inputs the granted POI code number into the CNS 100.

The controller 110 evaluates a current position on basis of information obtained by the GPS module 130, the motion detector 151, and the speedometer 152, compares the current position data with the positioning data corresponding to the POI code number, and then discloses navigating information of a position desired by the user, guiding the user (or driver) through a route to the destination) on the display unit 162.

The map information database 182 stores the POI code numbers and map information (including general and coordinate data) corresponding to the POI code numbers. Here, the POI code numbers are arranged in accordance with representative POI code numbers of high recognition levels, and provide code values during a searching process for geographic information. The database 182 is provided in the form of a handbook, or an optical/magnetic/semiconductor recording medium such as a CD-ROM, or a flash memory, so that a user can always identify the contents stored in the database 182 by means of a reader for the recording medium. The reader for the recording medium may be constructed in the navigation system as a part.

The input unit 120 generates a selection signal for enabling an institution name, which is located in a destination to be found by a user, to be selectively inputted to the CNS 100. Here, the input unit 120 is operable to transmit the selection signal by radio, using a key or a keyboard installed on a housing of the system (not shown), or an infrared remote controller. In this embodiment of the present invention, as the POI code numbers are classified into code values, the remote controller or a simple touch pad, equipped with a number panel, is available to be used therein.

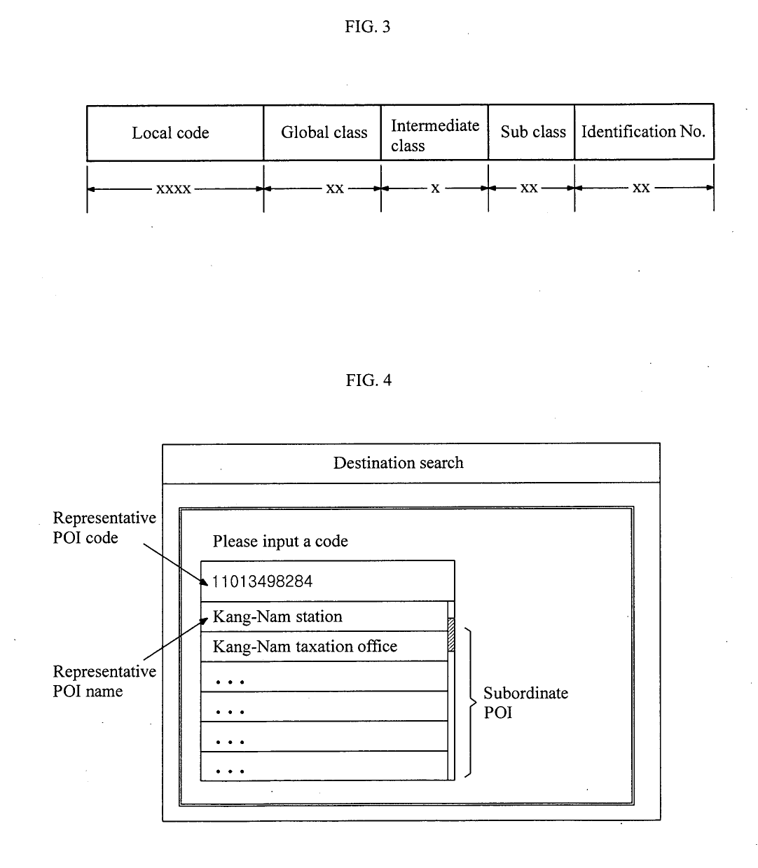

Referring to FIG. 3, the representative POI code number inputted through the input unit 120 is composed of eleven digits as an example, in which: the first four digits corresponds to a local information code to denote a town (e.g., “myeon”) or a village (e.g., “dong”) as a global domain; the next two digits distinguish administrative organizations, companies, educational facilities, medical facilities, monetary facilities, tourist spots, traffic sites, restaurants, residential districts, and so forth from the global domain by the first four digits; the next one digit as an intermediate domain divides the monetary facilities into the kinds of business such as for example banks, stock companies, and others; the next two digits as a sub domain classify the banks into ΔΔ bank, ◯◯ bank, □□ bank, [symbol] [symbol] bank, and so on; and the last two digits are an identification number that is an inherent number of the corresponding POI code number.

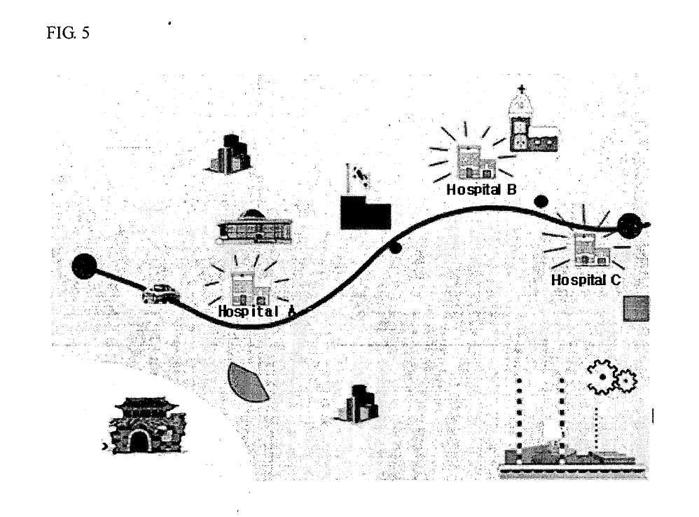

The controller 110 receives a signal outputted from the input unit 120, reads corresponding local information out of the map information database 182 and then applies the retrieved local information to the display unit 162. In the process by the controller 110, once a code value corresponding to a representative POI code number is inputted from the input unit 120, the local information about the peripherals is retrieved from the map information database 182 and then, outputted to the display unit 162. During this, the local information, i.e., the information involved in a subordinate POI code number, is figured out in a text form as shown in FIG. 4, or, although not shown, imaged with a two-dimensional map pattern. Moreover, a three-dimensional image may be distinctively associated with the two-dimensional map pattern.

When information for the subordinate POI code number is outputted to the display unit 162, the controller 110 confirms whether or not there is an input of a selection signal of a target institution, i.e., an input of an identification number in the system of POI code numbers, from the input unit 120 and then applies positioning information for a corresponding target institution and the best route from a starting institution to the target institution to the display unit 162. The identification number assigned to the target institution is obtained from an index number outputted from the controller 110, matching to the POI information, when a user who recognizes the POI information shown on the display unit 162 selects the corresponding target institution by using a direction key or number keys.

In addition, while displaying the route, if there is an input of a signal that corresponds to a classification code of an institution selected as a milepost by a driver, through the input unit 120, the controller 110 detects whether or not there is an institution matching with the corresponding classification code within a local area, which is being disclosed on the display unit 162, on the way of the route from the starting institution to the target institution with reference to the POI code numbers. If an institution assigned to the corresponding classification code is detected, the controller 110 enables a user to easily identify the institution by expressing it in a specific color or with flickering in order to be distinguishable from other subordinate POI code numbers as illustrated in FIG. 5.

Further, the map information database 182 stores geographic data according to a value of the POI code number and a code value for the subordinate POI code number, i.e., the identification number, and provides the stored geographic data to the controller 110 under control of the map processor 181.

The display unit 162 receives an operation control signal from the controller 110 and then shows a text or an image easily recognizable by a user.

Meanwhile, the configuration for assisting the input operation with the milepost codes by a user may be implemented in various methods by those skilled in the art. For example, after settling a milepost input menu key on the input unit 120, when a user strokes the milepost input menu key, the controller 110 makes the display unit 162 show a message guiding a sequence of inputting a milepost code and enable a user to input a business code of a corresponding milepost through the input unit 120. Otherwise, when a user has obtained information about a desired target institution, the controller 110 asks the user whether he will select a milepost through the display unit 162. If the user sends a signal to select the milepost, through the input unit 120, a message is displayed to guide a user to input a business code for the milepost by means of the input unit 120 or to select the code on the display unit 162.

Hereinafter, it will be described about an embodiment for searching geographic information in the navigation system of the present invention.

For instance, it is assumed that a user (or a driver) wants to find a restaurant. Usually, a user just knows there is an institution with high recognition around the restaurant, rather than an exact name of the restaurant, and a public name of the restaurant may be different in accordance with updating terms of a database. Therefore, after finding out a name of the highly recognized institution among the representative POI code values provided with the form of a handbook, the user inputs the representative POI code value corresponding to the highly recognized institution by means of the input unit 120.

Once the representative POI code value is entered, the controller 10 retrieves the peripheral POI information from the map information database 182 and then applies it to the display unit 162 in the form of a text or a two-dimensional image. As the result, the user can selects a target institution (e.g., the restaurant) in view of the information shown by the display unit 162.

As such, when a user selects a target institution by way of the input unit 120, the user is able to easily find out a position of a desired target institution by assistance with displaying the information, which is retrieved from the map information database 182 by the controller 110 in correspondence with the target institution, on the display unit 162.

In detail, when a user wants to go to a restaurant “A” and already knows a New York branch of a bank “B” around there, the user finds a code assigned to the New York branch of the bank “B” from a handbook containing the representative POI code numbers therein and then inputs the corresponding code by means of the input unit 120. After then, when the representative POI code number and its subordinate code numbers are shown on the display unit 162, the user scans and selects the restaurant “A” throughout a list of the subordinate POI code numbers. Consequently, the geographic data of the restaurant “A” is disclosed on the display unit 162.

On the other hand, if a user selects a hospital as a milepost, as illustrated in FIG. 5, the display unit 162 shows hospitals around the current traveling position, in the shape of flickering different from other institutions or in a three-dimensional image distinguishable from the peripherals depicted in two-dimensional graphic form. Thus, the user can acknowledge whether he is traveling along the correct way while checking names of the peripheral hospitals. It may be as matter of course for the milepost to be various kinds of institutions such as gas stations, banks, and so forth.

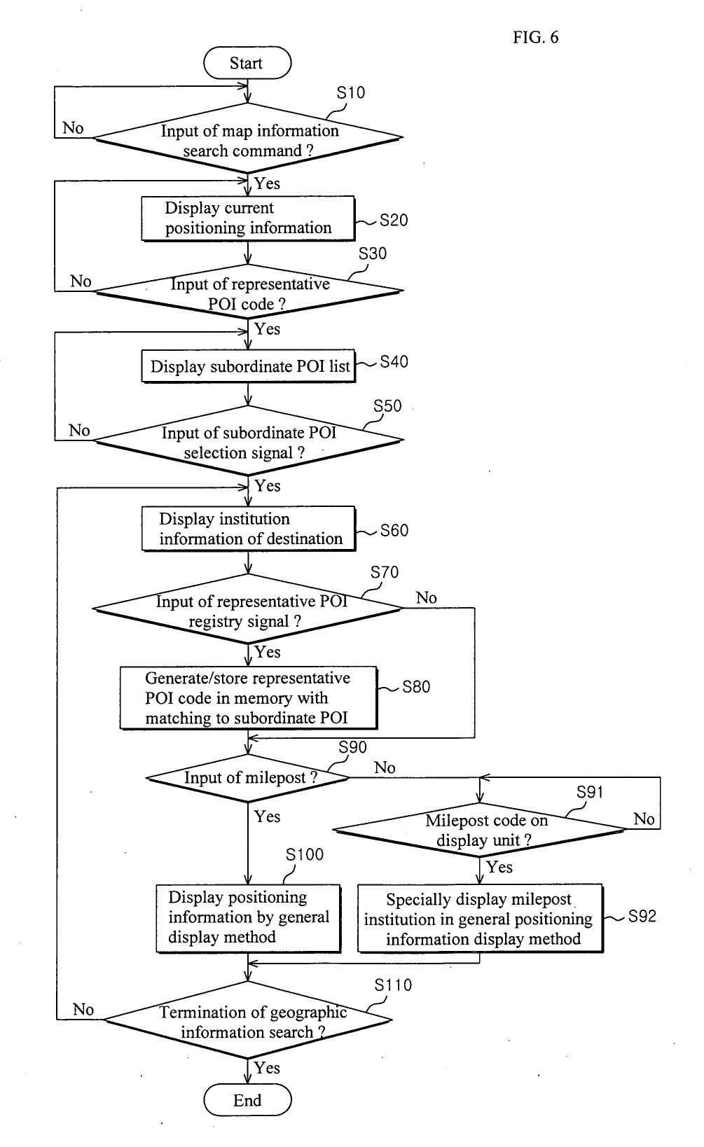

FIG. 6 is a flow chart showing a sequence of searching the POI code numbers.

First, the controller 110 checks out whether there is a command for searching geographic information with reference to a signal outputted from the input unit 120 (step S10). If the CNS 100 is operating, the controller 110 retrieves information about a current position of a vehicle from the map information database 182 and then enables it to be shown on the display unit 162 (step 20).

After displaying the current position of a vehicle, the controller 110 confirms whether there is an input of a representative POI code number with reference to a signal outputted from the input unit 120 (step S30). If there is an input of a representative POI code number, its subordinate POI list is disclosed on the display unit 162 in an alternative one of the text and image patterns (step S40). During this, it is available for a user to input the code after searching data recorded in a handbook, a CD-ROM, or the map information database 182.

After displaying the subordinate POI list, the controller 110 again confirms whether there is an input of a selection signal for a subordinate POI code number from the input unit 120 (step S50). If there is an input of a selection signal for a subordinate POI code number, subordinate POI information corresponding to the subordinate POI selection signal is retrieved from the map information database 182 and disclosed as a position of a target institution on the display unit 162 (step S60).

And, after showing the position of the target institution, the controller 110 applies an operation control signal to the display unit 162 to output a signal for asking a user if he wants to register a selected target institution for a new representative POI code number. From detecting a signal of the input unit 120 for a predetermined time, the controller 110 confirms whether there is a signal input (hereinafter, a representative POI registry signal input) for registering the selected target institution as the new representative POI code number (step S70).

At this time, if there is an signal input for registering a new representative POI code number in the step S70, a code for the representative POI is automatically generated by the new representative POI coding mechanism with reference to the selected subordinate POI code numbers and then subordinate POI information according to the newly generated representative POI code number is stored in the map information database 182 (step S80), which is possible by identifying the subordinate POI code numbers of institutions shown in the display unit 162.

By the way, although other procedure are not disclosed except the automatic generation of the representative POI code number, it is able to generate the representative POI code number by supplying a mode treatable by a user through the display unit 162.

Continuously, the controller 110 detects whether there is an input of a milepost name from the input unit 120 (step S90), while displaying information about a target institution as aforementioned. Unless there is an input for a milepost, positioning information (e.g., a traveling route) is disclosed on the display unit 162 in accordance with a general manner of displaying positioning information (step S100). If there is an input for a milepost, it detects whether an institution corresponding to a selected milepost code is existing on the display unit 162 (step S91).

In the step S91, if there is an institution assigned to the selected milepost code, the correspondent institution of the selected milepost is specifically illustrated by flickering, coloring, or in a three-dimensional pattern in order to differentiate it from others in a general displaying method for acquainting persons with positioning information (step S92).

During the procedure, the process of confirming whether an institution assigned to its corresponding milepost code is disclosed on the display unit 162 is easily modifiable by a person skilled in this art, not limiting the core concept of the present invention. For example, the controller 110 is able to detect whether a corresponding milepost code is included in an address of the map information database 182 that provides information about a local area being indicated at present.

With proceeding the above sequence, the controller 110 checks out whether there is a key input for terminating the search operation of geographic information (step S110). Unless there is a key input, it returns to the step S60 to continue displaying the current geographic information. If there is a key input for terminating the geographic information search, the displaying operation for the geographic information is terminated.

As a result, the present invention provides a simple and easy manner of finding a desired destination for a user.

Now, it will be described about a system for updating geographic information including the POI code numbers and method for operating the system, in accordance with the present invention.

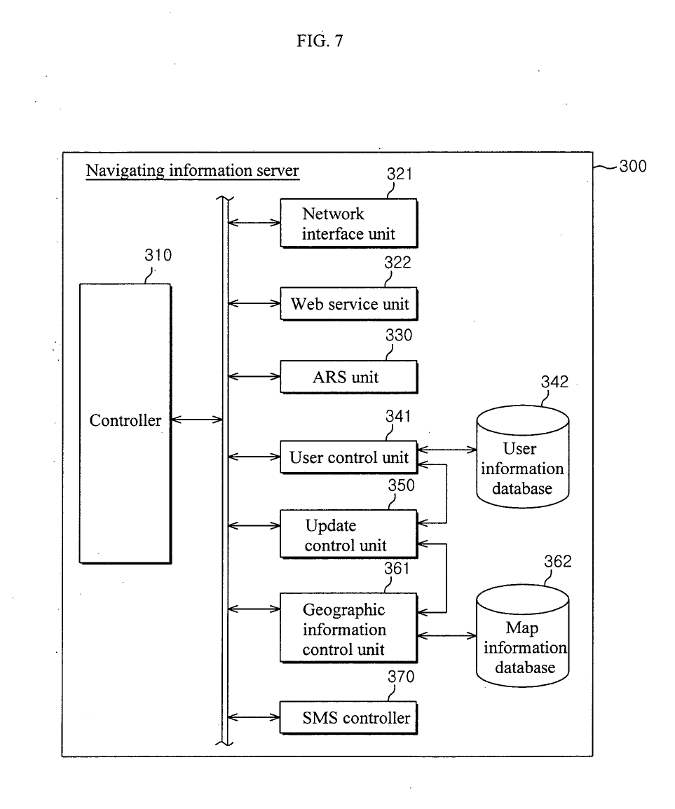

FIG. 7 is a block diagram illustrating a configuration of the navigating information server.

Referring to FIG. 7, the navigating information sever 300 is comprised of a controller 310 for managing an overall operation, a network interface 321 for connecting with a mobile communication network 200 or a personal terminal by way of the internet, a web service unit 322 for providing a web service on the internet, and an ARS unit 330 for providing an ARS service by way of a mobile communication terminal 20 or a wired telephone.

The navigating information server 300 also includes a user information database 342 for storing user information, a user control unit 341 for managing the user information database 342 with the user information, a map information database 362 for storing geographic information, a geographic information control unit 361 for managing the map information database 362 with the geographic information, an update control unit 350 for managing the geographic information control unit 361 to update the geographic information, and an SMS controller 370 for generating short messages to transfer to the mobile communication terminal 20 of a user, and analyzing and processing the short messages transferred from the mobile communication terminal 20 of a user.

In the meantime, the present invention also provides a function that a client (or a user), who wishes to register his favorite of geographic information in the database of the vehicle navigation system, is able to register desired geographic information, i.e., positioning information such as car centers, restaurants, hospitals, and so on, by transferring a message for requesting registry of the information to the navigating information server 300. The procedure for that will be described as follows.

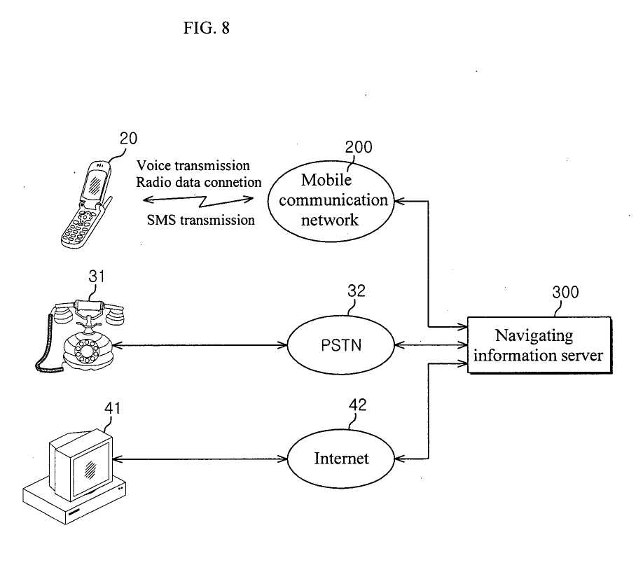

FIG. 8 is a block diagram of a configuration to receive request of positioning information registry by a user, according to the present invention.

Referring to FIG. 8, a user can access to the navigating information server 300 through the mobile communication network 200 by means of the mobile communication terminal 20, through a public communication network 32 (hereinafter, referred to as “PSTN”) by means of the wired terminal 31, or through the internet 42 by means of a personal terminal 41.

In the case of accessing to the navigating information server 300 by means of the mobile communication terminal 20, the user can be connected with the navigating information server 300 by practicing a radio data communication toward the mobile communication network 200 with the mobile communication terminal 20. Then, the navigating information server 300 provides a predetermined menu to the mobile communication terminal 20 accessing with the radio communication and accepts the registry request for the desired positioning information by receiving a reply transferred to the mobile communication terminal 20.

In case of accessing to the navigating information server 300 by means of the wired terminal 31, a user carries out a transmission with a predetermined telephone number. Then, the navigating information server 300 provides a predetermined voice guiding message to the wired terminal 31 accessing by way of the ARS unit 330 and accepts the registry request for the desired positioning information by receiving a reply transferred from the wired terminal 31 with reference to the voice guiding message. This process is also adoptable to a case of transmitting the request by voice with the mobile communication terminal 20.

In case of accessing to the navigating information server 300 by means of the personal terminal 41, a user is able to connect with a predetermined web site with a web browser by way of the internet 42. Then, the navigating information server 300 provides a predetermined web page to the personal terminal 41 accessing by way of the web service unit 322. And, when the personal terminal transmits a predetermined data for registry request of information with reference to a content included in the web page, the navigating information server 300 accepts the registry request for the desired positioning information by receiving the data from the personal terminal 41.

Otherwise, the mobile communication terminal 20 is capable of performing the registry request with a short message, transmitting the short message including a desired content to be registered to a predetermined phone number. Then, the mobile communication network 200 transfers the short message to the navigating information server 300 from the mobile communication terminal 20 and the SMS controller 370 of the navigating information server 300 receives the short message. The SMS controller 370 abstracts the information of the registry request from the short message and thereby the navigating information server 300 identifies the registry request for positioning information required by the user.

The content for registry of positioning information includes user information, a term (i.e., a name of the position to be registered), an address, or position data, as shown in the following table.

| User | | | |
|---|---|---|---|
| information | Item | Address information | Position data |
| — | ΔΔ car center, New | # □ of ΔΔΔ'th | Coordinate |
| | York | street, New York | information |

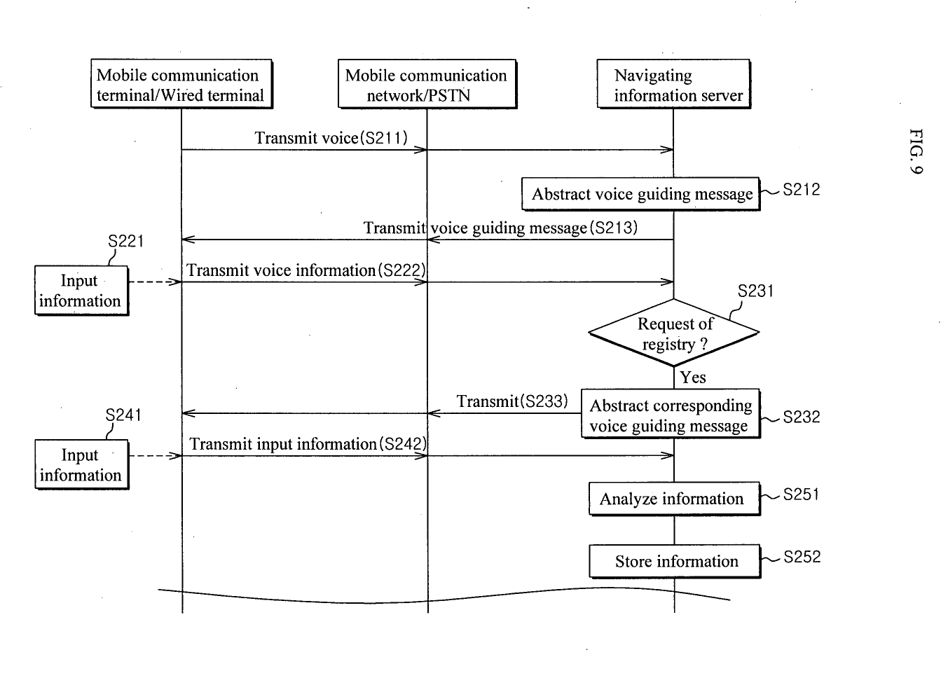

The detailed sequence of the aforementioned procedure will be described in conjunction with FIGS. 9 through 11.

FIG. 9 is a flow chart showing an embodiment of requesting registry by way of the mobile communication terminal or the wired terminal, according to the present invention.

Referring to FIG. 9, a user desiring registry of geographic information transmits a voice message to a predetermined phone number by means of the mobile communication terminal 20 or the wired terminal 31 (step S211). Then, the ARS unit 330 of the navigating information server 300 receives the voice message and then abstracts a prepared voice guiding message (step S212). The abstracted voice guiding message is transferred to the mobile communication terminal 20 or the wired terminal 31 (step S213).

According to that, the user inputs a predetermined information with reference to the voice guiding message after listening the voice guiding message (step S221). The information inputted by the user is transferred to the ARS unit 330 of the navigating information server 300 (step S222).

The ARS unit 330 confirms whether there is a registry request with reference to the information received in the step S222 (step S231). If it is regarded to as a registry request, a voice guiding message according to the registry request is abstracted (step S232) and then transferred to the mobile communication terminal or the wired terminal (step S233).

The user inputs information to be registered in accordance with the voice guiding message transferred thereto during the step S233 (step S241), and the inputted information is transferred to the ARS unit 330 of the navigating information sever 300 (step S242). At this time, the information may include a name, an address, and/or a coordinate value, of a position to be registered, as shown in the above table.

The ARS unit 330 of the navigating information server 300 analyzes the information transferred thereto during the step S242 (step S251). If the transferred information is configured with a DTMF tone, it searches predetermined data and analyzes the information in accordance with a tone corresponding thereto. If the transferred information is a voice, it identifies the voice and converts the voice into data.

Then, an analysis result of the information is stored in the navigating information server 300 (step S252). At this time, the navigating information server 300 stores the analyzed data in the map information database 362 by means of the geographic information control unit 361.

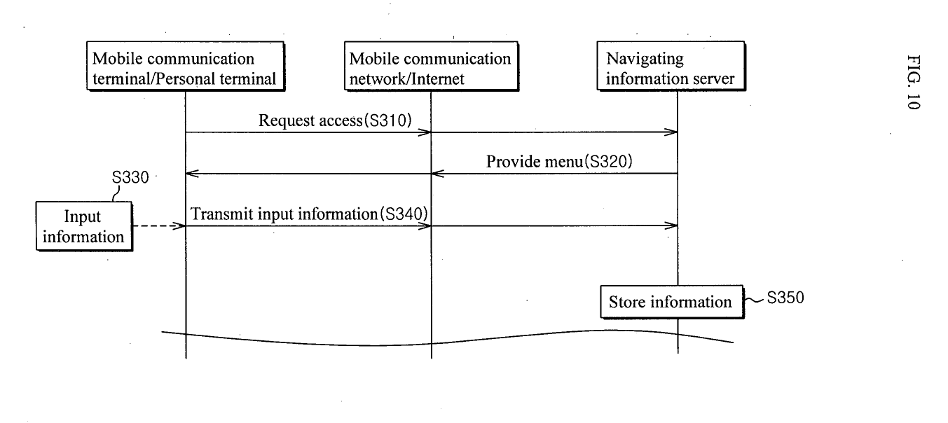

FIG. 10 is a flow chart showing an embodiment of requesting registry by way of a mobile communication terminal or a personal terminal, according to the present invention.

Referring to FIG. 10, a user who wants to register desired geographic information requests an access to a predetermined link address by way of the mobile communication terminal 20 or the personal terminal 41 (step S310). Then, the navigating information server 300 provides a prepared menu for the user in response to the access request (step S320).

Thus, the user selects a registry menu and inputs the information to be registered (step S330). The inputted information is transferred to the navigating information server 300 (step S340). At this time, the information may include a name, an address, and/or a coordinate value, of a position to be registered.

Then, the navigating information server 300 stores the information transferred thereto during the step S340 (step S350). At this time, the navigating information server 300 stores the analyzed data in the map information database 362 by means of the geographic information control unit 361.

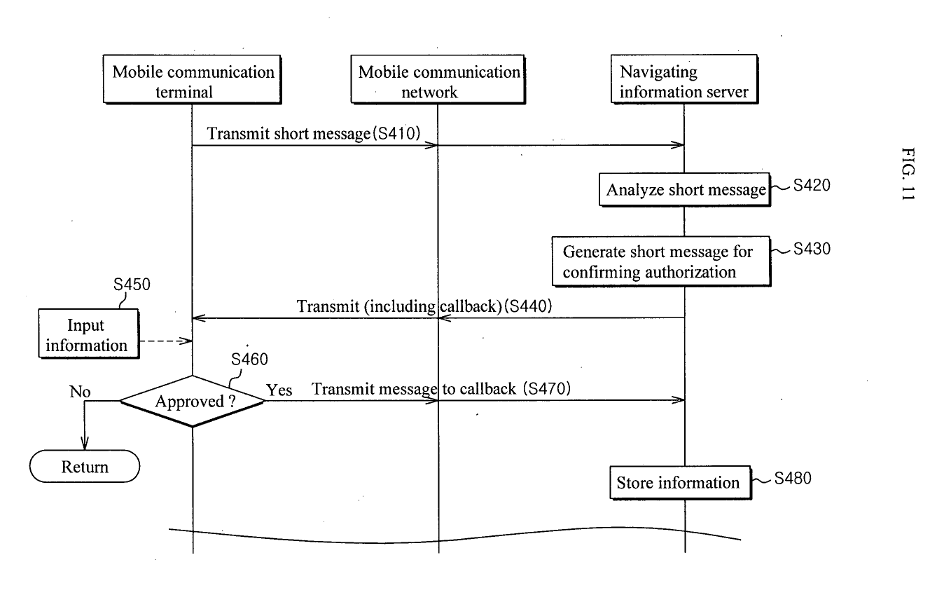

FIG. 11 is a flow chart showing an embodiment of requesting registry by way of a short message service, according to the present invention.

Referring to FIG. 11, a user desiring registry of geographic information transmits a short message by means of the mobile communication terminal 20 (step S410). At this time, the short message may include a name, an address, and/or a coordinate value, relevant to a position to be registered. The mobile communication network transmits the short message, which is transferred from the mobile communication terminal, to the navigating information server 300.

The SMS controller 370 of the navigating information server 300 receives and analyzes the short message (step S420). The SMS controller 370 generates a short message to confirm the approval of the user in accordance with the analyzing result (step S430) and then transmits the short message for the approval, including a callback number, to the mobile communication terminal (step S440).

The user receives the short message and inputs a confirmation command through a keypad of the mobile communication terminal when the received short message is correct (step S450). The mobile communication terminal transmits the short message to the callback number in accordance with the confirmation command (step S460).

Then, the SMS controller 370 receives the message transmitted thereto during the step S460 and stores the analyzed information obtained by the step S420, i.e., a name, an address, and a coordinate value, relevant to the position to be registered (step S470). At this time, the navigating information server 300 stores the analyzed data in the map information database 362 by means of the geographic information control unit 361.

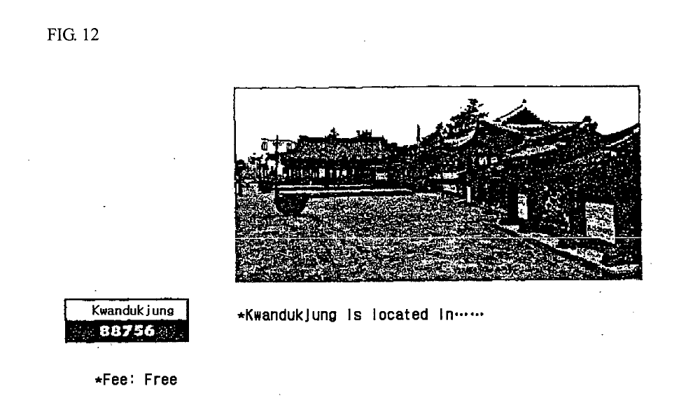

FIGS. 12 through 14 are schematic diagrams illustrating implementations of geographic information in accordance with the present invention.

Referring to FIG. 12, the geographic information according to the present invention can be noticed with assignment of tour guiding information per item (i.e., travel guiding information) that matches to a predetermined POI code number. For instance, when a tour item is “Kwandukjung”, the “Kwandukjung” is assigned to a POI code number “88756” that links to the tour guiding information (the information introducing “Kwandukjung”) and positioning information (a coordinate and/or an address).

Therefore, a user is able to have a tour item, guiding information, and positioning information, corresponding to the POI code number by inputting a POI code number to the CNS 100. The CNS 100 leads the user along a route from a current position to a place corresponding to the positioning information assigned to the POI code number that is input by the user.

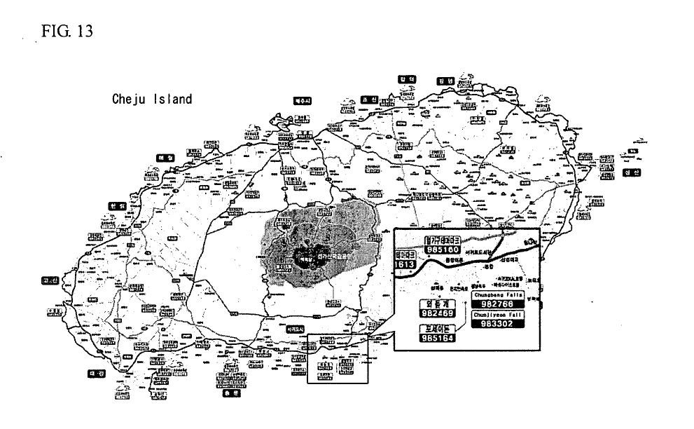

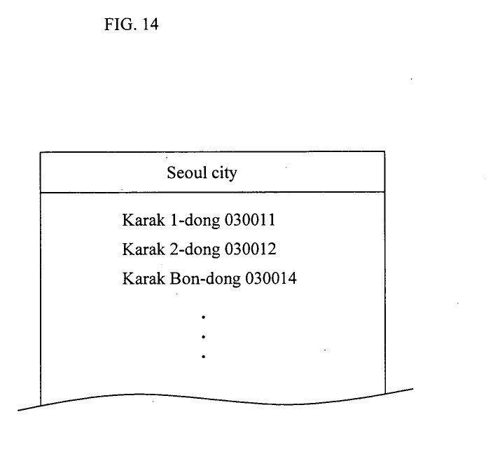

The information involved in the POI code number shown in FIG. 12 may be represented by matching a name marked on a roadmap with a predetermined POI code number, as shown in FIG. 13, or otherwise in the form of list as shown in FIG. 14. Also in this case, the map information database 182 of the CNS 100 stores and manages tour items, guiding information, and positioning information, corresponding to their POI code numbers.

Namely, the CNS 100 stores and manages tour items, guiding information, and positioning information, corresponding to their POI code numbers in the map information database 182, and when a user inputs a predetermined POI code number by means of the input unit 120, the controller 110 enables the map processor 181 to abstract a tour item, guiding information, and positioning information from the map information database 182 in correspondence with the input POI code number. The abstracted information is shown on the display unit 161 by the image processor 161.

And, the controller 110 evaluates a current position with reference to information obtained from the GPS module 130, the motion detector 151, and the speedometer 152, and compares the evaluation result with positioning information corresponding to the POI code number. After then, the guidance for route is carried out by way of the display unit 161, showing navigating information for a position desired by a user.

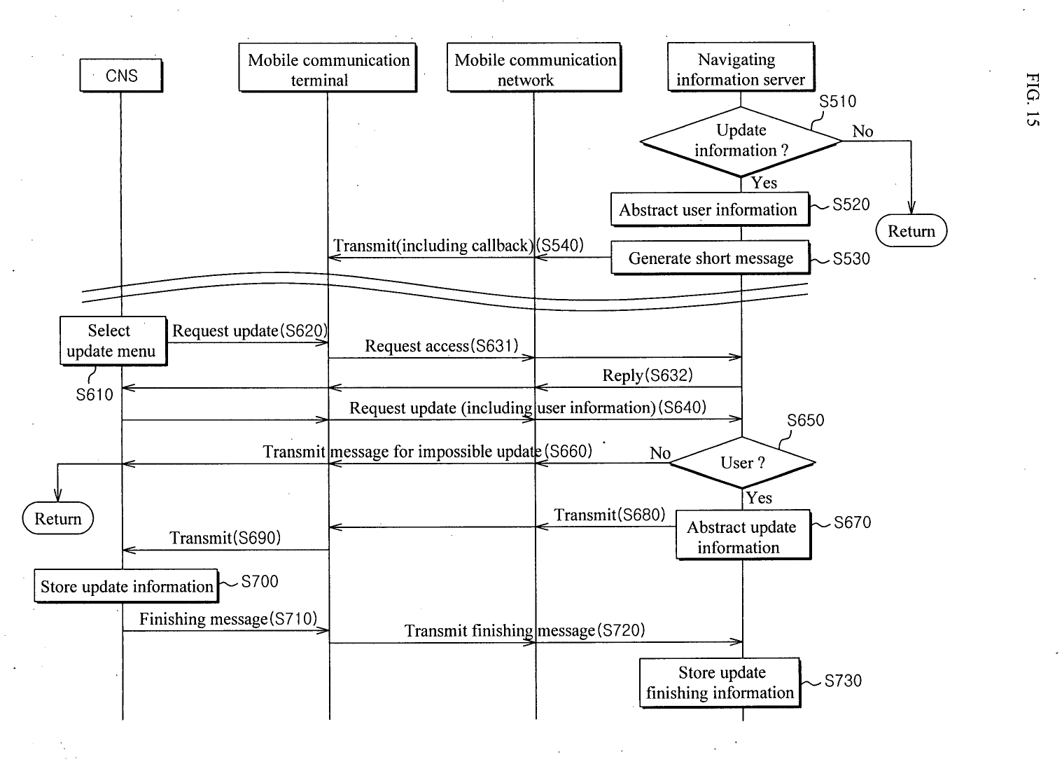

FIG. 15 is a flow chart showing a procedure of updating geographic information in accordance with the present information.

Referring to FIG. 15, the navigating information server 300 detects whether there is an update information by way of the update control unit 350 (step S510). If it detects an update information in the step S510, the update control unit 350 abstracts user information from the user control unit 341 (step S520). At this time, the user information may be a phone number of a user's mobile communication terminal.

The update control unit 350 enables the SMS controller 370 to generate a short message to inform the update of information in accordance with the abstracted user information (step S530). Then, the SMS controller 370 transmits the generated short message to the mobile communication terminal corresponding to the use information (step S540). At this time, the short message includes callback information.

On the other side, the user selects an update menu by means of the input unit 120 of the CNS 100 (step S610). Then, the controller 110 conducts an operation of update request by way of a mobile terminal interface unit 420 (step S620), and the mobile communication terminal requests an access to the navigating information server 300 by way of the mobile communication network (step S631).

The navigating information server 300 receives the access request and transmits a replying message for the access request to the mobile communication terminal, and the mobile communication terminal transfers the replying message to the CNS 100 (step S632). The controller 110 of the CNS 100 receives the replying message and then transmits an update request message to the navigating information server 300 by way of the mobile communication terminal (step S640). At this time, the update request message may include user information such as a management number of the CNS 100 or a phone number of the mobile communication terminal.

The navigating information server 300 receives the update request message and confirms whether it is transmitted from a registered user (step S650). At this time, the navigating information server 300 confirms the registered user with reference to a phone number of the mobile communication terminal transmitting the update request message or a management number of the CNS 100.

Unless the update request message corresponds to the registered user in the step S650, a message, including a note that it is impossible to update because he is not the registered user, is transmitted to the mobile communication terminal (step S660).

To the contrary, if it is determined as the registered user in the step S650, the navigating information server 300 abstracts update information through the update control unit 350 (step S670). At this time, the update control unit 350 operates the geographic information control unit 361 to abstract the corresponding update information from the map information database 362.

The update information can be arranged as the following table, including POI code numbers and positioning information (coordinates).

| | | Position |
|---|---|---|
| POI code number | Item | information |
| 12345 | ΔΔ car center, New York | . . . |
| 82346 | ◯◯ Restaurant, Washington | . . . |
| 88756 | □□ park, Washington | . . . |
| . | . | . |
| . | . | . |
| . | . | . |

According to this, the navigating information server 300 transmits the update information abstracted in the step S670 to the mobile communication terminal by way of the mobile communication network (step S680), and the mobile communication terminal transmits the update information received in the step S680 to the CNS 100 (step S690).

The controller 110 of the CNS 100 stores the update information, received during the step S690, in the map information database 182 through the map processor 181 (step S700), and transmits an update finishing message to the mobile communication terminal (step S710). The mobile communication terminal transfers the update finishing message to the navigating information server 300 (step S720).

The navigating information server 300 receives and stores the update finishing message received in the step S720 (step S730).

The geographic information update according to the present invention is also available by means of a personal terminal, i.e., a personal computer, as well as the mobile communication terminal. The CNS 100 is able to conduct the updating operation with the navigating information server through a web connection by means of the personal terminal, as follows.

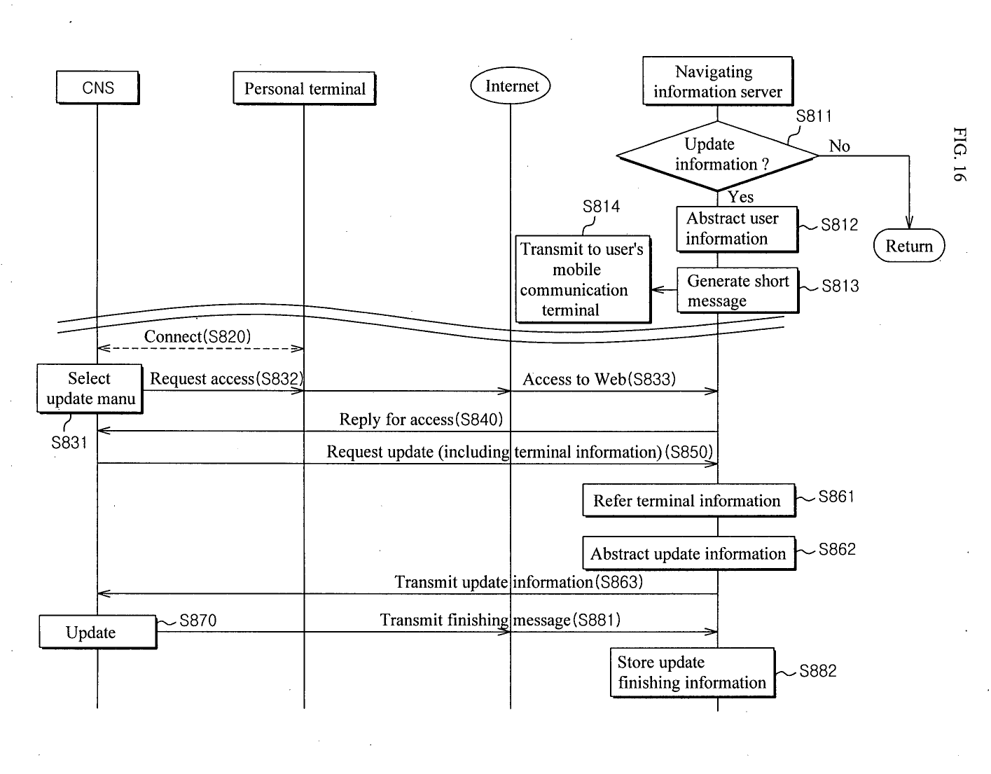

FIG. 16 is a flow chart showing another procedure of updating geographic information in accordance with the present information.

Referring to FIG. 16, the navigating information server 300 detects whether there is an update information by way of the update control unit 350 (step S811). If it detects an update information in the step S811, the update control unit 350 abstracts user information from the user control unit 341 (step S812). At this time, the user information may be a phone number of a user's mobile communication terminal.

The update control unit 350 enables the SMS controller 370 to generate a short message to inform the update of information in accordance with the abstracted user information (step S813). Then, the SMS controller 370 transmits the generated short message to the mobile communication terminal corresponding to the use information (step S814). At this time, the short message includes callback information. Thus, the user is able to recognize there is update information by receiving the short message through the mobile communication terminal.

The CNS 100 is connected to a personal terminal through the personal terminal interface unit 142 (step S820). Such connection may be easily implemented by a USB connection, or other various ways using a serial port, a parallel port, an IEEE 1394, wired/wireless LAN, and so on.

After connecting with the personal terminal, if an update menu is selected, the CNS 100 requests an access to the personal terminal in accordance with a predetermined access information (step S832) and then the personal terminal carries out a web connection to the navigating information server 300 in accordance with the access information (step S833). Then, the navigating information server 300 transmits a reply message responding to the connection (step S840).

The CNS 100 receiving the reply message in the step S840 transmits an update request message including CNS terminal information to the navigating information server 300, and the navigating information server 300 inquires the terminal information from the user information database 342 through the user control unit 341 on basis of the terminal information included in the update request message (step S851). From this operation, the authorization for user is carried out by the referred terminal information and the update information of the CNS terminal is confirmed. And, the update information is abstracted in accordance with the referred terminal information (step S862) and then transmitted to the CNS 100 (step S863).

The CNS 100 applies the update information, received during the step S863, to the map information database 182 through the map processor 181 (step S870), and transmits an update finishing message to the navigating information server 300 (step S881). The navigating information server 300 receives and stores the update finishing message corresponding to the CNS terminal (step S882).

According to the navigation system using POI code numbers, and the operating system and method for the same, of the present invention, since it is possible to simply search destinations by using POI code numbers, the efficiency in searching destinations is very improved. As it is available to input a code, an operation of buttons becomes simpler rather than the conventional case. It is also possible to operate a searching process for a desired destination by means of a simple remote controller without character input means.

In addition, it is convenient to a driver by accepting demands of a client who wants to register geographic information and then updating geographic information of a vehicle navigation system installed in a private car or a rent-a-car, capable of inputting a destination with the PO code number in order to simply search a route to the destination.

Although the present invention has been described in connection with the embodiment of the present invention illustrated in the accompanying drawings, it is not limited thereto. It will be apparent to those skilled in the art that various substitution, modifications and changes may be thereto without departing from the scope and spirit of the invention.

1. An operating system for managing geographical information of a navigation system, comprising a navigating information server which comprises:
a map information database for storing the geographic information matching to POI code numbers, including positioning information;
a geographic information control unit for managing the map information database with the geographic information; and
an update control unit for managing the geographic information control unit to update the geographic information, endowing the POI code number to update information when an update occurs, enabling the geographic information control unit to transmit updated geographic information including the POI code number to the vehicle navigation system through a communication network.

2. The operating system according to claim 1, wherein the navigating information server comprises a controller for managing an overall operation, a network interface unit for connecting with the vehicle navigation system, a user information database for storing user information, and a user control unit for managing the user information database;
wherein the vehicle navigation system comprises a mobile terminal interface unit for connecting with a mobile communication terminal or a personal terminal interface unit for connecting with a personal terminal; and
wherein the update control unit updates the geographic information of the vehicle navigation system by enable the geographic information control unit to transmit the updated geographic information to the mobile communication terminal connected with the mobile terminal interface unit, or to the personal terminal connected with the personal terminal interface unit, through the network interface unit when the update information is generated.

3. The operating system according to claim 2, wherein the navigating information server receives a registry request for geographic information from an external device, endows a POI code number to the geographic information of the registry request, and stores/manages the geographic information with the map information database by means of the update control unit.

4. The operating system according to claim 3, wherein the navigating information server further comprises a web service unit for providing a web service to receive the registry request for geographic information by an internet;
whereby the navigating information server endows a POI code number to the geographic information of the registry request when the web service unit receives the registry request for geographic information from a personal terminal through the internet, and stores/manages the geographic information with the map information database by means of the update control unit.

5. The operating system according to claim 3, wherein the navigating information server further comprises an ARS unit for providing a voice guiding message to receive the registry request for geographic information by voice transmission;
whereby the navigating information server endows a POI code number to the geographic information of the registry request when a voice message is received through a mobile communication terminal or a wired telephone, and stores/manages the geographic information with the map information database by means of the update control unit.

6. The operating system according to claim 3, wherein the navigating information server further comprises an SMS controller for providing a short message to receive the registry request for geographic information;
whereby the navigating information server abstracts the geographic information of the registry request by analyzing the short message when the short message including the geographic information of the registry request is received through the SMS controller, endows a POI code number to the abstracted geographic information, and stores/manages the geographic information with the map information database by means of the update control unit.

7. The operating system according to claim 3, wherein the message for the registry request of geographic information includes user information, an item (a position name to be registered) parameter, one of parameters of an address and positioning data as positioning information.

8. The operating system according to claim 7, wherein the address parameter is converted into positioning data in accordance with predetermined information; and the parameters are stored as the update information matching to the POI code number endowed by the navigating information server.

9. A navigation system using a POI code number, comprising:
a map information database for storing a POI code number assigned to information about region and business, corresponding to institutions involved in street and building names with high recognition;
a display unit for outputting a signal corresponding to an operation control signal input thereto;
an input unit for inputting the POI code number; and
a controller for applying information matching with the POI code number to the display unit from the map information database, in accordance with the POI code number provided through the input unit.

10. The navigation system according to claim 9, wherein the map information database stores detail information including representative POI codes involved in information about region and business, corresponding to representative institutions including street and building names with high recognition, subordinate POI codes assigned to peripheral institutions within a regular range under the representative POI code, and detail information including addresses or coordinates each for the subordinate codes;
wherein the input unit is used for directly inputting the representative POI code corresponding to a desired destination by a user with reference to values of the representative POI codes recorded in the map information database or for selecting the subordinate POI codes corresponding to a destination by a user; and
wherein the controller applies the subordinate POI list to the display unit from a storage unit when the representative POI code is received in accordance with a signal from the input unit, and applies information about a corresponding institution to the display unit from the storage unit when the subordinate POI code is selected by the input unit.

11. The navigation system according to claim 10, wherein the representative POI code includes a local code, a plurality of class codes hierarchically arranged and identification number.

12. The navigation system according to claim 10, wherein the subordinate POI code is formed by adding an identification number to the representative POI code corresponding thereto.

13. The navigation system according to claim 10, wherein the subordinate POI code is subject to a plurality of the representative POI codes with duplication, and a representative geographic name corresponding to the representative POI code is assigned to a subordinate POI code of another representative POI code.

14. The navigation system according to claim 10, wherein the subordinate POI code is applied to the display unit in the form of two-dimensional or three-dimensional image, or text.

15. The navigation system according to claim 10, wherein the input unit is an infrared remote controller or a touch panel.

16. The navigation system according to claim 10, wherein the controller further outputs an operation control signal to the input unit, the display unit, and the map information database so as to enable a user to select an institution of business to be adoptable as a milepost among routes between a target institution and a starting institution by means of the input unit, the display unit, and the map information database, and further applies an operation control signal to the display unit so as to enable a user to identify the institution of business within a guiding region disclosed on the display unit when the milepost is selected.

17. A method of operating a navigating information system having a navigating information server managing geographic information of a vehicle navigation system, comprising:
a first step of endowing a POI code number to an update information when the update information for the geographic information is generated;
a second step of storing the update information with matching to the endowed POI code number;
a third step of abstracting pre-registered user information using the vehicle navigation system; and
a fourth step of transmitting the POI code number and the update information matching to the POI code number to the vehicle navigation system by way of a communication network in accordance with the abstracted user information in the third step.

18. The method according to claim 17, further comprising:
a step of generating a short message for informing the update of geographic information after the second step; and
a step of transmitting the short message to a mobile communication terminal corresponding to a user's mobile phone number included in the user information abstracted in the third step.

19. The method according to claim 18, wherein the short message includes a callback and the fourth step is carried out when an approval message is received through the callback.

20. The method according to claim 17, wherein the information transmitted by the fourth step includes the POI code number, an item representing a name matching to the POI code number, and positioning information (address and/or coordinate).

21. The method according to claim 17, wherein the generation of the update information in the first step arises from a registry request for geographic information by way of a SMS, an ARS, or a web.

22. The method according to claim 21, wherein the registry request for geographic information includes user information, an item (a position name to be registered) parameter, and one of parameters of an address and positioning data as positioning information.

23. The method according to claim 22, wherein the address parameter is converted into coordinate information in accordance with predetermined information.

24. The method according to claim 17, wherein the vehicle navigation system comprises a mobile terminal interface unit to connect with a mobile communication terminal or a personal terminal interface unit to connect with a personal terminal;
wherein in the fourth step, the geographic information of the vehicle navigation system is updated by transmitting the POI code number and the update information matching to the POI code number to the mobile communication terminal connected with the mobile terminal interface unit or the personal terminal connected with the personal terminal interface unit.

25. A method for searching with a navigation system applying information to a display unit when inputting a name of a target institution through an input unit, comprising:
a first step of establishing a database by endowing POI code numbers to institutions and matching the POI numbers with geographic information;
a second step of receiving a POI code number supplied from the input unit; and
a third step of providing the geographic information of a corresponding institution to a user by searching the POI code number received in the second step, abstracting the geographic information matching to the POI code number, and applying the geographic information to the display unit.

26. The method according to claim 25, wherein the first step comprises a step of establishing the database by matching local and business information with representative POI code numbers assigned to institutions having high recognition among the geographic information, and a step of recording detail information including names and addresses or coordinates, corresponding to subordinate POI code numbers that are assigned to institutions located within a regular range around the representative POI numbers of the database, in the form of text or image;
wherein the second step receives the representative POI code number; and
wherein the third step comprises a step of abstracting a subordinate POI list according to the representative POI code number, and a step of enabling a user to select a target institution that is disclosed on the display unit;
wherein information about the target institution is provided when one code corresponding to the target institution is selected on the subordinate POI list.

27. The method according to claim 25, further comprising a fourth step of enabling a user to select an institution of business guiding a corresponding route by means of the input unit when information about a target institution is obtained in the third step and distinguishably showing the corresponding institution located within a guiding region.

28. The method according to claim 26, further comprising a fourth step of, when information about another target institution but an institution of the representative POI is obtained in the third step, confirming if the user wants to register a new representative POI code number generated automatically or storing the new representative POI code number or a representative POI code number supplied by the user.
